(19) United States
(12) Patent Application Publication
(10) Pub. No.: US 2026/0141260 A1
(43) Pub. Date: May 21, 2026

(54) RENDERING METHOD AND APPARATUS USING VARIABLE NEURAL NETWORK MODEL

(71) Applicant: SAMSUNG ELECTRONICS CO., LTD., Suwon-si (KR)

(72) Inventor: Donghoon SAGONG, Suwon-si (KR)

(73) Assignee: SAMSUNG ELECTRONICS CO., LTD., Suwon-si (KR)

(21) Appl. No.: 19/171,856

(22) Filed: Apr. 7, 2025

(30) Foreign Application Priority Data
Nov. 15, 2024 (KR) 10-2024-0163162

(51) Int. Cl. G06N 3/10

(52) U.S. Cl. CPC G06N 3/10

(57) ABSTRACT

A rendering method and apparatus using a neural network (NN) model are provided. The rendering method includes estimating a performance state value of a device by monitoring a performance state of the device in real time; determining, based on the estimated performance state value, whether to change a neural network (NN) model; performing rendering by using a selected NN model that is selected according to a result of the determining whether to change the NN model; and determining whether to change the selected NN model by monitoring a result of the rendering and the performance state of the device in real time.

### CROSS-REFERENCE TO RELATED APPLICATION

This application claims priority to Korean Patent Application No. 10-2024-0163162, filed on Nov. 15, 2024, in the Korean Intellectual Property Office, the disclosure of which is incorporated by reference herein in its entirety.

### BACKGROUND

### 1. Field

The disclosure relates to a rendering method and apparatus using a neural network (NN) model.

### 2. Description of Related Art

The use of neural networks (NNs) in digital devices is rapidly expanding in various application fields. An inference process using an NN model may play an essential role in the fields such as image recognition, natural language processing, and computer vision. Particularly, the use of NNs on mobile devices has become increasingly important.

Since mobile devices, especially smartphones, tablets, and augmented reality (AR)/virtual reality (VR) devices have relatively limited computation capability, solving performance issues may be a critical challenge when real-time inference is performed using an NN model. Mobile devices are equipped with high-performance processors such as a graphics processing unit (GPU) and a neural processing unit (NPU), but their performance may change in real time depending on various conditions such as, e.g., temperature, power consumption, and processor utilization rates.

### SUMMARY

One or more embodiments may address at least the above problems and/or disadvantages and other disadvantages not described above. Also, the embodiments are not required to overcome the disadvantages described above, and an embodiment may not overcome any of the problems described above.

According to an aspect of the disclosure, a rendering method may include: estimating a performance state value of a device by monitoring a performance state of the device in real time; determining, based on the estimated performance state value, whether to change a neural network (NN) model; performing rendering by using a selected NN model that is selected according to a result of the determining whether to change the NN model; and determining whether to change the selected NN model by monitoring a result of the rendering and the performance state of the device in real time.

The estimating of the performance state value of the device may include combining state data of the device and performance data of rendering based on a data fusion method.

The combining the state data of the device and the performance data of rendering may include: determining a performance value of the device based on the state data of the device, the state data including at least one of a processor temperature, a processor utilization rate, and a power consumption of the device; determining a performance value of the rendering based on the performance data of the rendering, the performance data of the rendering including at least one of rendering frames per second, an inference time of the NN model, and a number of elements in a scene; and determining the performance state value of the device by obtaining a weighted sum of the performance value of the device and the performance value of the rendering.

The NN model may be trained to change based on a number of parameters or an upsample ratio of the NN model.

The rendering method may further include, based on determining to change the NN model, changing the NN model to a performance model or a quality model based on the estimated performance state value.

The changing the NN model may include, based on the estimated performance state value being greater than or equal to a threshold value, changing the NN model to the performance model.

The quality model may be trained to be changed into a quality model corresponding to a rendering environment, by using a loss function considering temporal quality and spatial quality.

The changing the NN model may include, based on the estimated performance state value being less than a threshold value, changing the NN model to the quality model.

The changing the NN model to the quality model may include changing the NN model to a quality model corresponding to a motion intensity (MI), based on the MI occurring in a rendering environment of the device.

The MI may be determined by fusing a real-time MI and a content-specific MI.

The determining the performance state value of the device by obtaining the weighted sum of the performance value of the device and the performance value of the rendering may include determining the performance state value of the device including a motion intensity (MI).

The determining whether to change the NN model may include, based on the NN model currently performing rendering being determined to be appropriate for the estimated performance state value, maintaining the NN model as the selected NN model.

The rendering method may further include adjusting an input value of the NN model based on the estimated performance state value.

The adjusting the input value of the NN model may include adjusting the input value based on an input patch size or a center position.

The input patch size may be adjusted inversely proportional to the estimated performance state value.

The center position may be determined using a center of a display, a foreground area of a depth map, or a saliency map.

The result of the rendering may be a result of synthesizing a rendering result output according to the adjusted input value at the center position.

The rendering method may further include selecting an NN model corresponding to the adjusted input value.

According to an aspect of the disclosure, a non-transitory computer-readable storage medium stores instructions that, when executed by a processor, cause the processor to perform a rendering method including: estimating a performance state value of a device by monitoring a performance state of the device in real time; determining, based on the estimated performance state value, whether to change a neural network (NN) model; performing rendering by using a selected NN model that is selected according to a result of the determining whether to change the NN model; and determining whether to change the selected NN model by monitoring a result of the rendering and the performance state of the device in real time.

According to an aspect of the disclosure, a device includes: a memory configured to store instructions; and at least one processor, wherein the instructions, when executed by the at least one processor individually or collectively, cause the device to: estimate a performance state value of the device by monitoring a performance state of the device in real time; determine, based on the estimated performance state value, whether to change the neural network (NN) model; perform rendering by using a selected NN model that is selected according to a result of the determining whether to change the NN model; and determine whether to change the selected NN model by monitoring a result of the rendering and the performance state of the device in real time.

Additional aspects of embodiments will be set forth in part in the description which follows and, in part, will be apparent from the description, or may be learned by practice of the disclosure.

### BRIEF DESCRIPTION OF THE DRAWINGS

The above and/or other aspects will be more apparent by describing certain embodiments with reference to the accompanying drawings, in which:

FIG. 1 is a flowchart illustrating a rendering method using a variable neural network (NN) model, according to an embodiment;

FIG. 2 is a flowchart illustrating an operation of a device driving a variable NN model, according to an embodiment;

FIG. 3 is a diagram schematically illustrating a rendering NN model according to an embodiment;

FIG. 4 is a flowchart illustrating a method of adjusting an input value of a rendering NN, according to an embodiment;

FIG. 5 is a flowchart illustrating an operation of a device driving a variable NN model, according to an embodiment; and

FIG. 6 is a block diagram illustrating an electronic device according to an embodiment.

### DETAILED DESCRIPTION

The following detailed structural or functional description is provided as an example only and various alterations and modifications may be made to the embodiments. Accordingly, the embodiments are not construed as limited to the disclosure and should be understood to include all changes, equivalents, and replacements within the idea and the technical scope of the disclosure.

Although terms, such as first, second, and the like are used to describe various components, the components are not limited to the terms. These terms should be used only to distinguish one component from another component. For example, a first component may be referred to as a second component, and similarly the second component may also be referred to as the first component.

It should be noted that if one component is described as being “connected”, “coupled”, or “joined” to another component, a third component may be “connected”, “coupled”, and “joined” between the first and second components, although the first component may be directly connected, coupled, or joined to the second component.

The singular forms “a”, “an”, and “the” are intended to include the plural forms as well, unless the context clearly indicates otherwise. It will be further understood that the terms “comprises/comprising” and/or “includes/including” when used herein, specify the presence of stated features, integers, steps, operations, elements, and/or components, but do not preclude the presence or addition of one or more other features, integers, steps, operations, elements, components and/or groups thereof.

As used herein, “A or B”, “at least one of A and B”, “at least one of A or B”, “A, B or C”, “at least one of A, B and C”, and “at least one of A, B, or C,” each of which may include any one of the items listed together in the corresponding one of the phrases, or all possible combinations thereof. For example, the expression, “at least one of A, B, and C,” should be understood as including only A, only B, only C, both A and B, both A and C, both B and C, or all of A, B, and C.

Unless otherwise defined, all terms, including technical and scientific terms, used herein have the same meaning as commonly understood by one of ordinary skill in the art to which the present disclosure pertains. Terms, such as those defined in commonly used dictionaries, should be construed to have meanings matching with contextual meanings in the relevant art, and are not to be construed to have an ideal or excessively formal meaning unless otherwise defined herein.

The embodiments may be implemented as various types of products such as, for example, a personal computer, a laptop computer, a tablet computer, a smart phone, a television, a smart home appliance, an intelligent vehicle, a kiosk, and a wearable device. Hereinafter, the embodiments will be described in detail with reference to the accompanying drawings. When describing the embodiments with reference to the accompanying drawings, like reference numerals refer to like components and a repeated description related thereto will be omitted.

In the field of neural network (NN) graphics, a computer graphics application may require a fast and accurate rendering result, and a user may expect consistent rendering quality even under a condition of varying performance. However, on mobile devices, it may be inefficient to use the same NN model under various situations of performance load, and accordingly, an NN model may need to be changed variably.

A neural architecture search (NAS) method, one of related art technologies, may search for an optimal layer configuration of an NN to eliminate unnecessary operations and may find a lightweight NN model suitable for a mobile environment. However, the NAS method may have a structure of using only a single NN model and may not be able to properly respond to device performance loads that change in real time.

A knowledge distillation (KD) method, which is another method, is a training method of obtaining a high-quality result from an NN model with a small number of parameters. This method may improve efficiency by transferring knowledge learned from a large NN model (e.g. a teacher model) to a smaller NN model (e.g. a student model). However, the KD method may also have a limitation that the method may not change the NN in real time and needs to use a fixed model.

Therefore, in an environment such as mobile devices, the NN model may need to be variably changed to correspond to a real-time performance state of a device. Accordingly, fast inference may be performed by selecting a lightweight model when computation capability of the device is insufficient, and a result of higher quality may be generated by using a high-quality NN model when performance is sufficient.

The embodiments described below may provide a description of an NN for generating a rendering image in NN-based computer graphics. For example, NNs may include super-resolution (or super-sampling) NNs and ray tracing denoiser NNs, and all of these may generate realistic computer graphics rendering images as output.

The device may be a device that may install and run a server-related application and may provide an interface to the user. The interface may be provided by a terminal itself. For example, the interface may be provided by an operating system (OS) of the device or may be provided by an application installed on the device. In addition, the interface may be provided by the server, and the device may simply receive and display the interface provided by the server.

Real-time rendering NN inference on the device may be highly dependent on performance load of the device. As the performance load on the device increases, the amount of computation available for the NN inference may decrease, thereby reducing rendering NN inference speed. There may be various factors that may cause an increase in the performance load. For example, the amount of computation required may vary depending on types or complexity of content that needs to be processed during rendering. As the content becomes more complex, or as other applications are executed simultaneously on the same device, the amount of computation available for the rendering may decrease. In addition, environmental factors such as increased device temperature or increased power consumption may also degrade the performance.

The embodiments described below may provide a description of a method of variably utilizing an NN model so that NN inference may be performed stably at a predetermined speed even under a condition of device performance load that fluctuates in real time. When the performance load is large, an NN model with a small number of parameters may be used to perform inference quickly, and when the performance load is small, a large NN model that may generate higher quality results may be selected and utilized.

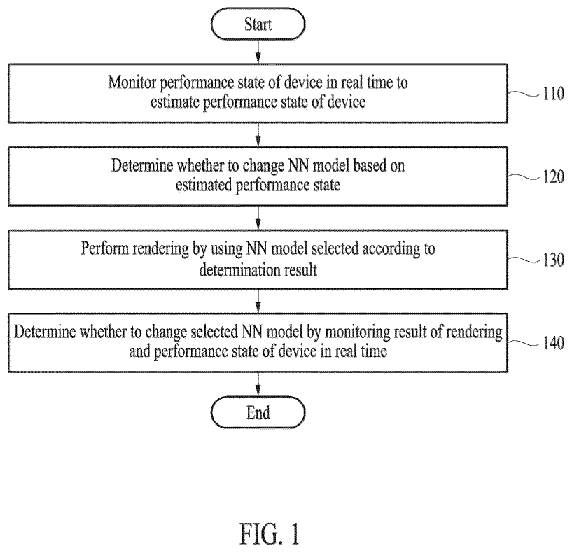

FIG. 1 is a flowchart illustrating a rendering method using an NN model, according to an embodiment.

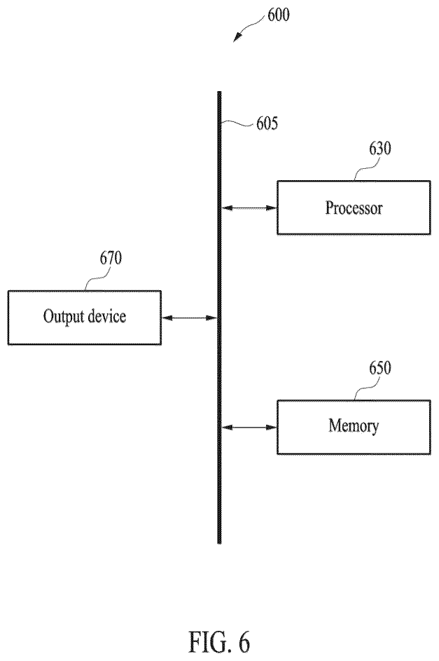

For ease of description, operations 110 to 140 are described as being performed by an electronic device 600 illustrated in FIG. 6. However, operations 110 to 140 may be performed by another suitable electronic device in a suitable system.

Furthermore, the operations of FIG. 1 may be performed in the shown order and manner. However, the order of some operations may be changed, or some operations may be omitted, without departing from the spirit and scope of the shown embodiment. The operations shown in FIG. 1 may be performed in parallel or simultaneously. Hereinafter, an electronic device (e.g., the electronic device 600 of FIG. 6) may be referred to as a device 100.

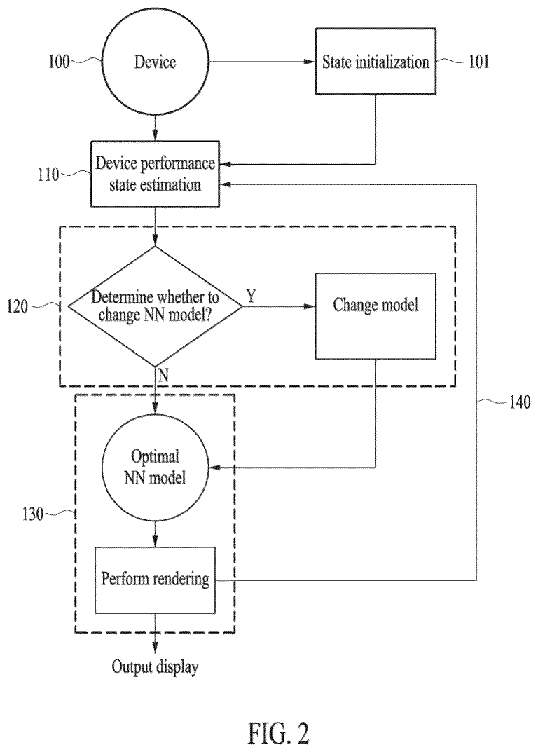

FIG. 2 is a flowchart illustrating an operation of a device driving a variable NN model, according to an embodiment.

Referring to FIGS. 1 and 2 together, the device 100 may perform rendering by using a variable NN model.

In operation 110, the device 100 may monitor a performance state (e.g., performance overhead (PO)) of the device 100 in real time to estimate a performance state value of the device 100. The performance state of the device 100 may need to be accurately identified in order to select an optimal NN model, thereby obtaining a high-quality rendering result.

According to an embodiment, the device 100 may combine state data of the device 100 with performance data of rendering based on a data fusion method. Data fusion may be a method of combining data collected from various sources to estimate accurate and reliable information. Kalman filtering, decision trees, and random forests may be used as real-time data fusion algorithms that are used to calculate the performance state value in the device 100.

The Kalman filtering is an algorithm of estimating a state of a system based on data including noise. The Kalman filtering may be particularly suitable for data that changes in real time and may repeat a process of predicting a current state and correcting prediction using actual measured data. Accordingly, data that has lots of noise and changes rapidly, such as sensor data or system performance, may be processed accurately. The Kalman filtering may be used in a variety of fields, including real-time tracking, location estimation, and robot control.

The Kalman filtering may have an advantage of estimating an accurate value from real-time data including noise. Data such as processor temperature, processor utilization rates, and power consumption may be sensor inference values and thus may include noise. Rendering NN inference time, frames per second (FPS), etc. may be a measurement value that is measured in real time and may have large deviations. In order to estimate accurate performance load (PO) of the device 100 by combining various pieces of data, the Kalman filtering may have the advantage of improving accuracy by fusing multiple pieces of data. iii) PO estimation may need to occur in real time, and since the Kalman filtering performs fixed-size matrix operations with little computation burden, the Kalman filtering may be suitable for utilization of real-time applications.

A decision tree is a tree-structured algorithm for classifying or predicting data. Each node may branch out based on particular characteristics of the data and may ultimately determine a class to which the data belongs or may predict a value.

A random forest is an ensemble learning technique of improving prediction performance by combining multiple decision trees. Each decision tree may be trained independently using a portion of the data, and final prediction may be determined by synthesizing prediction results of each tree. The random forest may complement the shortcomings of the decision tree, may reduce overfitting, may improve prediction performance, and may achieve powerful performance in various application fields.

In the embodiments described below, a method of estimating the performance state value of the device 100 by using the Kalman filtering is described. However, embodiments are not limited thereto, and one of ordinary skill in the art may estimate the performance state value of the device 100 by using another method.

First, in a state initialization process in operation 101, the Kalman filtering may be initialized. The Kalman filtering is a mathematical model for estimating a state of a system and may require setting initial values of state variables that a filter tracks in the initialization process. These initial values may represent a current state of the system. For example, the state variables such as processor temperature, utilization rates, and power consumption of the device 100 may be set to the initial values.

In addition, in the state initialization process in operation 101, an error covariance matrix may be initialized to provide information about errors (uncertainty) that the state variables may have. The error covariance matrix may reflect a correlation between each state variable and may be usually set to a diagonal matrix when initialized. Each element of the diagonal matrix may represent the initial error of the corresponding state variable. For example, an initial error value of processor temperature may reflect uncertainty according to sensor measurement, and a higher initial error value may indicate lower confidence in the corresponding state.

In the state initialization process in operation 101, a default rendering NN may be set. An NN model to be used basically according to the initial performance state of the device 100 may be selected, and a default rendering NN model may be dynamically changed according to a performance load state of the device 100.

Finally, a threshold value that is a standard for selecting a rendering NN may be set. For example, when the performance load of the device 100 exceeds a particular threshold value, an NN model with a small amount of computation may be used, and when the performance load is below the threshold value, the threshold may be set such that an NN model with a large amount of computation may be used.

The state data used in the Kalman filtering to estimate the performance state value of the device 100 may include data related to the state of the device 100 (e.g., processor temperature, processor utilization rates, and battery power consumption of the device 100) and rendering performance data (e.g., rendering image FPS, rendering NN inference time, and the number of elements (e.g., triangles) expressed in a current rendering scene).

According to an embodiment, the device 100 may determine the performance value of the device 100 based on the state data of the device 100 including at least one of processor temperature, processor utilization rates, and power consumption of the device 100. For example, the performance value of the device 100 may be determined through Equation 1 below.

$$device performance value = ( processor temperature + processor utilization rate + power consumption ) \qquad [ Equation 1 ]$$

Here, in order to determine the performance value of the device 100, processor temperature, processor utilization rates, and power consumption may be converted to a predetermined ratio through normalization scaling that may be performed by one of ordinary skill in the art.

The device 100 according to an embodiment may determine the performance value of the rendering based on the performance of the rendering including at least one of rendering FPS, inference time of the NN model, and the number of elements in a scene. In three-dimensional (3D) graphics, elements may be basic components included in a surface of an object. The more elements are used, the more detailed and complex the scene becomes, and more calculations may be required to render this. For example, a triangle may be an example of a representative element. A triangle may be mainly used as a basic unit included in a surface of a 3D model, and a complex 3D object may be expressed as mesh cells that are divided into multiple triangles. The mesh cells may be included in not only triangles but also squares or other types of cells. In 3D simulation, each element may be a unit that may independently calculate deformation, collision, stress, and displacement. The elements may gather together to represent a physical behavior of an entire object, and interactions between individual elements may cause simulation of physical properties of the entire system.

According to an embodiment, the performance value of the rendering may be determined through Equation 2.

$$rendering performance value = ( NN inference time + \frac{1000}{FPS} + number of elements in scene ) \qquad [ Equation 2 ]$$

Likewise, the data for determining rendering the performance values may also be converted to a predetermined ratio through normalization scaling that may be performed by one of ordinary skill in the art.

According to an embodiment, the device 100 may determine the performance state value (e.g., a PO value) of the device 100 by obtaining a weighted sum of the performance value of the device 100 and the performance value of the rendering. The performance state value of the device 100 may be determined through Equation 3.

$$PO = α \times device performance value + β \times rendering performance value \qquad [ Equation 3 ]$$

Here, α and β may be constants experimentally determined as weights for the performance state value of the device 100 and the performance value of the rendering, respectively. Both the performance of the device 100 and the rendering performance may be values that change in real time and may be measured in real time.

In operation 120, the device 100 may determine whether to change the NN model based on the estimated performance state value. For example, the device 100 may perform variable rendering by using an estimated PO value. The variable rendering may be a method of selecting and utilizing an NN that corresponds to a current PO estimated value among several rendering NN models.

The NN model may be trained to change variably depending on the number of parameters of the NN model or an upsample ratio. The upsample ratio may be a ratio that indicates how much input data is enlarged when low-resolution data is converted to high-resolution data in image or video processing. The upsample ratio may be mainly used in NN-based super resolution or sampling techniques. Upsampling may be a process of converting a smaller input image to a larger resolution output image, and during this process, the number of pixels may be increased or details may be added.

For example, there may be a quality model and a performance model. The quality model may be an NN model with a large number of trainable parameters and a large amount of computation that prioritizes quality of an output rendering image. The quality model may have a slow inference speed but may generate higher quality rendering images. On the contrary, the performance model may reduce the number of trainable parameters, thereby having fast NN inference speed but providing relatively low-quality rendering results. For example, when the PO estimated value is low, the quality model may be selected continuously. However, when the rendering is determined to be unsuitable according to the performance state, whether to change the NN model to the performance model or the quality model may be determined.

The device 100 according to an embodiment may maintain the corresponding NN model when the NN model currently performing the rendering is determined to be appropriate for the estimated performance state value.

The device 100 according to an embodiment may determine whether to change the NN model to the performance model or the quality model when the NN model is determined to be changed based on the estimated performance state value.

The device 100 according to an embodiment may change the NN model to the performance model when the estimated performance state value is greater than or equal to the threshold value.

The quality model may be trained to be changed into the quality model corresponding to a rendering environment, by using a loss function considering temporal quality and spatial quality.

The device 100 according to an embodiment may change the NN model to the quality model when the estimated performance state value is less than the threshold value.

The device 100 according to an embodiment may change the NN model to the quality model corresponding to motion intensity (MI), based on the MI occurring in the rendering environment of the device.

The MI may be determined by fusing real-time MI and content-specific MI.

The device 100 may select a rendering NN that reflects the motion size in a current scene. For example, the real-time MI may be determined based on motion vector (MV) information provided by a game, and the content-specific MI may use a predefined value depending on a game type.

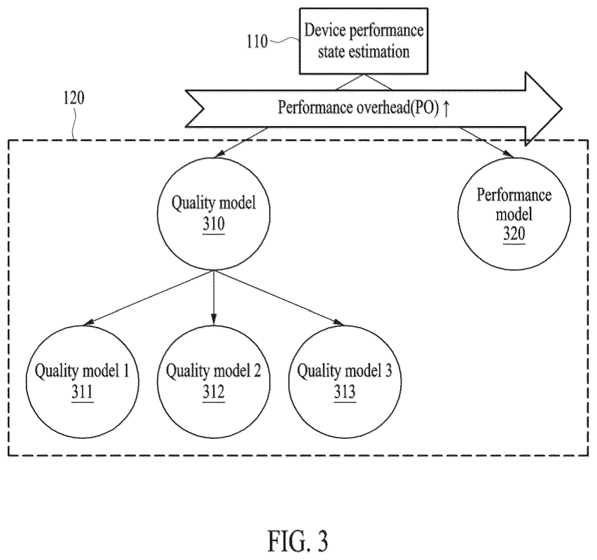

The device 100 according to an embodiment may determine the performance state value of the device 100, including the MI. In FIG. 3 described below, a process of selecting the performance model and the quality model by the device 100 is described in detail.

In operation 130, the device 100 may perform rendering by using the NN model selected according to a determination result. For example, when the device 100 selects the performance model, the device 100 may quickly generate a relatively low-quality image by prioritizing rendering speed. On the contrary, when the quality model is selected, the device 100 may generate images with higher resolution and detail by prioritizing rendering quality.

In operation 140, the device 100 may determine whether to change the selected NN model by monitoring a result of the rendering and the performance state of the device 100 in real time. For example, when the performance load of the device 100 increases during the rendering and the FPS decreases, the NN model may be changed to the performance model to improve the performance. On the contrary, when the performance state is stable, the quality model may be maintained to continue high-quality rendering.

FIG. 3 is a diagram schematically illustrating a rendering NN model according to an embodiment.

The description provided with reference to FIGS. 1 and 2 may apply to FIG. 3, and any repeated description related thereto may be omitted.

In operation 110, a PO value may be determined through estimation of a performance state of the device 100, and based on the PO value, the device 100 may select an NN model to be used for rendering.

A rendering NN model according to an embodiment may be divided into a quality model 310 and a performance model 320. The quality model 310 may be an NN model that has high quality of output rendered images (e.g., peak signal-to-noise ratio (PSNR)) but slow inference speed. The quality model 310 may be a model that prioritizes rendering quality and may have characteristics of having a large number of trainable parameters. The quality model 310 may require greater computation for NN inference due to the large number of parameters, so the quality model 310 may be utilized when an available computation amount of the device 100 is large (or when the PO value of the device 100 is low).

The performance model 320 may be an NN model that has fast inference speed but a low-quality output rendering image. The performance model 320 may have characteristics of fast NN inference speed by minimizing the number of trainable parameters. The performance model 320 may be utilized when available computation capacity of the device 100 is low.

When comparing configurations of the performance model 320 and the quality model 310, the quality model 310 may be configured as a relatively larger model with a larger amount of computation than the performance model 320. For example, the quality model 310 may be configured by having a larger number of layers (e.g., standard convolutional layers) or by having a relatively larger number of input/output channels of intermediate layers. In addition, for super-resolution (or super-sampling) rendering NNs, an upsampling ratio may be configured to be lower. For example, when the same target resolution is H×W, an H/2×W/2 image size input may be calculated when the upsampling ratio is 2, and an H/3×W/3 size input may be calculated when the upsampling ratio is 3. In the former case, the input may be large, so the amount of computation may be relatively large. Since the input size becomes smaller and the amount of computation decreases as the upsample ratio increases, the performance model 320 may be appropriate in the case where high-speed inference is required.

In operation 120, when the PO value is low, the performance model 320 may be selected. The quality model 310 may be further divided into a first quality model 311, a second quality model 312, and a third quality model 313, which may respectively include a spatial quality model, an overall quality model, and a temporal quality model.

The first quality model 311 may be the spatial quality model that improves image quality by prioritizing spatial details of each pixel. The second quality model 312 may be the overall quality model that considers a balance between temporal quality and spatial quality. The third quality model 313 may be a temporal quality model that emphasizes temporal quality and may focus on minimizing flickering in pixel changes between frames.

On the contrary, when the PO value increases greater than or equal to the threshold value, the performance model 320 that prioritizes operation speed may be selected. The performance model 320 may have fast NN inference speed and may be optimized to perform real-time rendering without interruption even when the device 100 is under a state of performance load.

In other words, the selection between the quality model 310 and the performance model 320 may be determined by the PO estimated value of the device 100. For example, when the PO estimated value is greater than or equal to a threshold value t, as shown in Equation 4 below, the performance model 320 may be selected.

$$NN = \{ \begin{matrix}{NN}_{{perf}_{.}} & if PO \geq τ \\ {NN}_{{qual}_{.}} & if PO < τ\end{matrix} \qquad [ Equation 4 ]$$

Through this process, rendering output without interruption regardless of a real-time computational load state of the device 100 may be generated. In addition, optimal quality may be obtained by maximizing available operations of the device 100.

The spatial quality may measure similarity between a color value of each pixel location in a measurement image and a color value of a pixel in a ground truth image. The temporal quality may compare temporal changes in color of the same pixel in multiple consecutive rendering frames to each other, in the measurement image and the ground truth image.

In general, the more precisely the color values of each pixel in the output rendering image are expressed, the higher the spatial quality, but pixel flickering may occur in consecutive frames, thereby lowering the temporal quality. When pixel color values of the output rendering image are expressed as blurry, the spatial quality may be low, but the temporal flickering may be reduced, thereby increasing the temporal quality.

Therefore, the temporal quality and the spatial quality may have a trade-off relationship. In order to configure a rendering NN model considering the temporal quality and the spatial quality, a loss function as shown in Equation 5 below may be used mainly during NN training. For example, the loss function for the NN training may be configured as follows.

$$ℒ = w {ℒ}_{spatial} + ( 1 - w ) {ℒ}_{temporal} \qquad [ Equation 5 ]$$

An overall loss function [symbol] of the NN model may be expressed as a weighted sum of a loss function [symbol] ₛₚₐₜᵢₐₗ for the spatial quality and a loss function [symbol] ₜₑₘₚₒᵣₐₗ for the temporal quality. When the spatial quality and the temporal quality have a trade-off relationship, the weighted sum of each may be w and 1−w, respectively. By adjusting the weighted sum of the loss function, the quality model 310 may be divided into the spatial quality model, the overall quality model, and the temporal quality model. For example, the quality model 310 may be configured as the temporal quality model when the size of w is small (e.g., w<<0.5), as the spatial quality model when w is large (e.g., w>>0.5), and as the overall quality model when the size is intermediate (e.g., w [symbol] 0.5). Here, the weight w may be determined experimentally, and the quality model 310 may be trained in advance.

$${NN}_{{q}_{spatial}} = NN trained with ℒ ( w ≫ 0.5 ) \qquad [ Equation 6 ]$$

$${NN}_{{q}_{overall}} = NN trained with ℒ ( w {}_{}^{.} {=}_{.}^{} 0.5 )$$

$${NN}_{{q}_{temporal}} = NN trained with ℒ ( w ≪ 0.5 )$$

MI may be used to select one of three NNs. The MI may be determined by a real-time measurement value and a predefined value for each content. For example, the MI may be obtained as the sum of real-time MI and content-specific MI.

The real-time MI may be determined by confirming (e.g., using the maximum MV value of all pixels) MV (movement speed of objects in content per pixel) information provided for each frame in a game. The real-time MI may vary within the same game depending on differences in game scene complexity or user interaction and may be measured as a large value when screen changes of a current scene are significant during game play.

The content-specific MI may be a value predetermined for each content. For example, for racing games and first-person games, the MI may be set to be high, and for third-person games and casual games, the MI may be set to low.

The MI may be estimated together with PO by being fused with other data in a data fusion algorithm such as Kalman filtering. The PO may also be defined hierarchically, with or without including MI values, depending on a usage scenario.

The MI may be determined as shown in Equation 7 below, and an NN detailed model of the quality model 310 may be determined as shown in Equation 8 below, by comparing the threshold values. γ may be a value for adjusting the real-time MI and the content-specific MI.

$$γ * real time MI value + ( 1 - γ ) * content specific MI value \qquad [ Equation 7 ]$$

$${NN}_{qual} = \{ \begin{matrix}{NN}_{{q}_{spatial}} & if MI < τ \\ {NN}_{{q}_{overall}} & if {τ}_{1} \leq MI < {τ}_{2} \\ {NN}_{{q}_{temporal}} & if {τ}_{2} \leq MI\end{matrix} \qquad [ Equation 8 ]$$

The NN detailed model determined in such a method may provide optimal rendering output that reflects motion size characteristics and content characteristics of the current rendering scene.

The three quality models 310 are only an example and embodiments are not limited thereto. The quality model 310 may be trained using three or fewer models or may be trained to have a greater number of quality models 310.

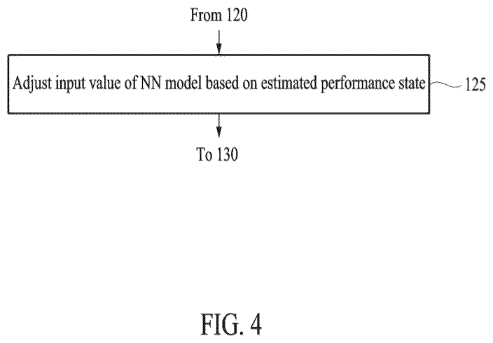

FIG. 4 is a flowchart illustrating a method of adjusting an input value of a rendering NN, according to an embodiment.

The description provided with reference to FIGS. 1 to 3 may apply to FIG. 4, and any repeated description related thereto may be omitted.

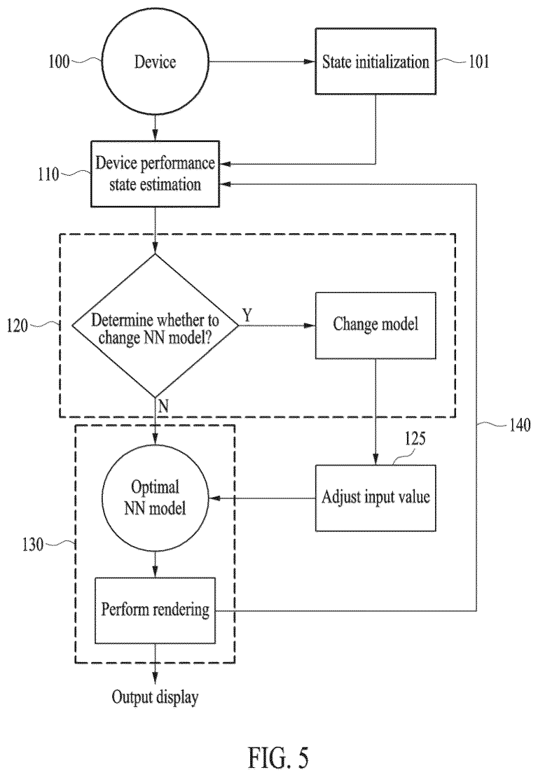

FIG. 5 is a flowchart illustrating an operation of a device driving a variable NN model, according to an embodiment.

Referring to FIGS. 4 and 5 together, when the device 100 is estimated to have a very high PO value, the computational load of the device 100 may be very large, resulting in a lack of available computation capability. Therefore, a real-time inference operation may be difficult even in a performance model. In this case, by adjusting the size of an area to be rendered, which is an input value, basic rendering (e.g., low resolution rendering) may be performed in unimportant areas and high resolution rendering may be performed in important areas by using an NN model, thereby performing rendering without interruption.

In operation 125, the device 100 may adjust the input value of the NN model based on an estimated performance state value. Here, the input value may be determined by an input patch size and a center position. The input patch size may include the width and the height of an NN input in a rectangle, and the center position may refer to the center point of this rectangle.

The device 100 according to an embodiment may adjust the input value based on the input patch size or the center position. The input patch size may be adjusted to be inversely proportional to an estimated performance state value. As the performance load of the device 100 increases, the amount of computation for NN inference may be decreased by reducing the input patch size, thereby maintaining real-time performance. On the contrary, when the performance load is low, a larger input patch may be used to obtain a result of higher quality.

For example, the input patch size may be adjusted to be inversely proportional to an estimated PO value. As the PO value increases, the available computation amount decreases, so the input patch size may be adjusted to be smaller to reduce the computation amount required for the NN inference. For example, when the height and the width of the input patch size are h and w, the input patch size (h, w) may be set to the minimum size of (hₘᵢₙ, wₘᵢₙ) and then may be adjusted as α×(hₘᵢₙ, wₘᵢₙ). Here, α may be a value inversely proportional to the PO value. As the PO value increases, the input patch size decreases, which may reduce the amount of computation.

The center position may be determined using the center of a display, a foreground area of a depth map, or a saliency map. The center position may be set to a method of selecting an important area for rendering and focusing on the important area, and accordingly high-quality rendering may be performed in important screen areas. For example, the center of a screen where the main character of a game is located or an area including many important objects in a depth map may be set as the center position.

The final rendering result may be a result of synthesizing a rendering result output according to the adjusted input value at the center position. When the input patch size and the center position are determined, the device 100 may process a portion rather than the entire screen and may then synthesize the portion with a basic rendered image based on the center position to generate the final rendering result. Accordingly, the performance may be optimized by applying higher resolution to important areas and processing the remaining areas at a relatively lower resolution.

The device 100 according to an embodiment may select an NN model corresponding to the adjusted input value. When a single NN has difficulty in processing variable input patch sizes, an NN model that is appropriate for a current situation may be selected from among several NN models that are prepared in advance. For example, one may be selected from among NNs of various sizes, such as NN_size1, NN_size2, etc., by comparing a PO estimated value to a threshold value, and the threshold value may be determined experimentally. The NN model selected in this method may then undergo the same process of synthesizing results according to the center position after the adjusted input value is processed.

For example, when a super-resolution (super-sampling) NN is used, super-resolution rendering may be performed by setting a screen area (e.g., the center of the display or the foreground area of the depth map) where the main character is located as the center position.

More specifically, when an upsample ratio is 2 in the super-resolution NN, a screen size may be (H, W) and an input image size of the super-resolution NN may be (H/2, W/2). Here, when an input patch size is (h, w), an output patch size may be (2h, 2w). Here, the input patch size may be less than or equal to the input image size of the NN, and the output patch size may be less than or equal to the screen size. The device 100 may synthesize an output patch at the center position to generate the final rendering result. Accordingly, only the area where the main character of the game is located is processed as super-resolution, thereby providing high-quality results in the important areas and allowing fast NN inference.

In another example, the screen size may be (H, W), and the input image size of the super-resolution NN may be (H, W). Here, when the input patch size is (h, w), the output patch size may be (h, w). Here, the input patch size may be less than or equal to the input image size of the NN, and the output patch size may be less than or equal to the screen size. The device 100 may synthesize an output patch at the center position to generate the final rendering result. Therefore, by selecting an area with a large light effect as an input patch in a ray tracing denoiser NN, fast NN inference and rendering results of appropriate quality may be simultaneously obtained.

FIG. 6 is a block diagram illustrating an electronic device according to an embodiment.

Referring to FIG. 6, an electronic device 600 may include a processor 630, a memory 650, and an output device 670 (e.g., a display). The processor 630, the memory 650, and the output device 670 may be connected to one another through a communication bus 605. The electronic device 600 may include the processor 630 for performing at least one method described above for operating the electronic device 600 or an algorithm corresponding to the at least one method.

The output device 670 may display a rendering output result provided by the processor 630. The output device 670 may be the same as the display included in the device 100. In addition, the output device 670 may be embedded in the electronic device 600 to display the rendering output result or may be an external display device.

The memory 650 may store data related to a rendering operation using a variable NN model performed by the processor 630. In addition, the memory 650 may store various pieces of information generated in the process of the processor 630 described above. In addition, the memory 650 may store a variety of data and programs. The memory 650 may include a volatile memory or a non-volatile memory. The memory 650 may store a variety of data by including a large mass storage medium, such as a hard disk.

Also, the processor 630 may perform at least one method described with reference to FIGS. 1 to 5 or an algorithm corresponding to one or more of the methods. In the above-described process, the processor 630 may be a hardware-implemented data processing device having a circuit that is physically structured to execute desired operations. For example, the desired operations may include code or instructions in a program. The processor 630 may be implemented as, for example, a central processing unit (CPU), a graphics processing unit (GPU), or an NN processing unit (NPU). The electronic device 600, which is implemented as hardware, may include, for example, a microprocessor, a CPU, a processor core, a multi-core processor, a multiprocessor, an application-specific integrated circuit (ASIC), and a field-programmable gate array (FPGA).

The processor 630 may execute a program and control the electronic device 600. Program code to be executed by the processor 630 may be stored in the memory 650.

The processor 630 may estimate a performance state value of the device 100 by monitoring a performance state of the device 100 in real time, may determine whether to change an NN model based on the estimated performance state value, may perform rendering by using an NN model selected according to a result of the determining, and may determine whether to change the selected NN model by monitoring a result of the rendering and the performance state of the device 100 in real time.

The embodiments described herein may be implemented using a hardware component, a software component, and/or a combination thereof. A processing device may be implemented using one or more general-purpose or special-purpose computers, such as, for example, a processor, a controller and an arithmetic logic unit (ALU), a digital signal processor (DSP), a microcomputer, an FPGA, a programmable logic unit (PLU), a microprocessor, or any other device capable of responding to and executing instructions in a defined manner. The processing device may run an OS and one or more software applications that run on the OS. The processing device also may access, store, manipulate, process, and generate data in response to execution of the software. For purpose of simplicity, the description of a processing device is used as singular; however, one skilled in the art will appreciate that a processing device may include multiple processing elements and multiple types of processing elements. For example, a processing device may include multiple processors or a processor and a controller. In addition, different processing configurations are possible, such as parallel processors.

The software may include a computer program, a piece of code, an instruction, or combinations thereof, to independently or uniformly instruct or configure the processing device to operate as desired. Software and/or data may be embodied permanently or temporarily in any type of machine, component, physical or virtual equipment, computer storage medium or device, or in a propagated signal wave capable of providing instructions or data to or being interpreted by the processing device. The software may also be distributed over network-coupled computer systems so that the software is stored and executed in a distributed fashion. The software and data may be stored in a non-transitory computer-readable recording medium.

The methods according to the above-described embodiments may be recorded in non-transitory computer-readable media including program instructions to implement various operations of the above-described embodiments. The media may also include, alone or in combination with the program instructions, data files, data structures, and the like. The program instructions recorded on the media may be those specially designed and constructed for the purposes of embodiments, or they may be of the kind well-known and available to those having skill in the computer software arts. Examples of non-transitory computer-readable media include magnetic media such as hard disks, floppy disks, and magnetic tape; optical media such as compact disc read-only memory (CD-ROM) discs and digital video discs (DVDs); magneto-optical media such as optical discs; and hardware devices that are specially configured to store and perform program instructions, such as read-only memory (ROM), random access memory (RAM), flash memory, and the like. Examples of program instructions include both machine code, such as produced by a compiler, and files containing higher-level code that may be executed by the computer using an interpreter.

While the embodiments are described with reference to drawings, it will be apparent to one of ordinary skill in the art that various alterations and modifications in form and details may be made in these embodiments without departing from the spirit and scope of the claims and their equivalents. For example, suitable results may be achieved if the described techniques are performed in a different order, and/or if components in a described system, architecture, device, or circuit are combined in a different manner, and/or replaced or supplemented by other components or their equivalents.

Therefore, other implementations, other embodiments, and equivalents to the claims are also within the scope of the following claims.

What is claimed is:

1. A rendering method comprising:
estimating a performance state value of a device by monitoring a performance state of the device in real time;
determining, based on the estimated performance state value, whether to change a neural network (NN) model;
performing rendering by using a selected NN model that is selected according to a result of the determining whether to change the NN model; and
determining whether to change the selected NN model by monitoring a result of the rendering and the performance state of the device in real time.

2. The rendering method of claim 1, wherein the estimating of the performance state value of the device comprises combining state data of the device and performance data of rendering based on a data fusion method.

3. The rendering method of claim 2, wherein the combining the state data of the device and the performance data of rendering comprises:
determining a performance value of the device based on the state data of the device, the state data comprising at least one of a processor temperature, a processor utilization rate, and a power consumption of the device;
determining a performance value of the rendering based on the performance data of the rendering, the performance data of the rendering comprising at least one of rendering frames per second, an inference time of the NN model, and a number of elements in a scene; and
determining the performance state value of the device by obtaining a weighted sum of the performance value of the device and the performance value of the rendering.

4. The rendering method of claim 1, wherein the NN model is trained to change based on a number of parameters or an upsample ratio of the NN model.

5. The rendering method of claim 1, further comprising, based on determining to change the NN model, changing the NN model to a performance model or a quality model based on the estimated performance state value.

6. The rendering method of claim 5, wherein the changing the NN model comprises, based on the estimated performance state value being greater than or equal to a threshold value, changing the NN model to the performance model.

7. The rendering method of claim 5, wherein the quality model is trained to be changed into a quality model corresponding to a rendering environment, by using a loss function considering temporal quality and spatial quality.

8. The rendering method of claim 5, wherein the changing the NN model comprises, based on the estimated performance state value being less than a threshold value, changing the NN model to the quality model.

9. The rendering method of claim 8, wherein the changing the NN model to the quality model comprises changing the NN model to a quality model corresponding to a motion intensity (MI), based on the MI occurring in a rendering environment of the device.

10. The rendering method of claim 9, wherein the MI is determined by fusing a real-time MI and a content-specific MI.

11. The rendering method of claim 3, wherein the determining the performance state value of the device by obtaining the weighted sum of the performance value of the device and the performance value of the rendering comprises determining the performance state value of the device including a motion intensity (MI).

12. The rendering method of claim 1, wherein the determining whether to change the NN model comprises, based on the NN model currently performing rendering being determined to be appropriate for the estimated performance state value, maintaining the NN model as the selected NN model.

13. The rendering method of claim 1, further comprising:
adjusting an input value of the NN model based on the estimated performance state value.

14. The rendering method of claim 13, wherein the adjusting the input value of the NN model comprises adjusting the input value based on an input patch size or a center position.

15. The rendering method of claim 14, wherein the input patch size is adjusted inversely proportional to the estimated performance state value.

16. The rendering method of claim 14, wherein the center position is determined using a center of a display, a foreground area of a depth map, or a saliency map.

17. The rendering method of claim 14, wherein the result of the rendering is a result of synthesizing a rendering result output according to the adjusted input value at the center position.

18. The rendering method of claim 13, further comprising:
selecting an NN model corresponding to the adjusted input value.

19. A non-transitory computer-readable storage medium storing instructions that, when executed by a processor, cause the processor to perform a rendering method comprising:
estimating a performance state value of a device by monitoring a performance state of the device in real time;
determining, based on the estimated performance state value, whether to change a neural network (NN) model;
performing rendering by using a selected NN model that is selected according to a result of the determining whether to change the NN model; and
determining whether to change the selected NN model by monitoring a result of the rendering and the performance state of the device in real time.

20. A device comprising:
a memory configured to store instructions; and
at least one processor,
wherein the instructions, when executed by the at least one processor individually or collectively, cause the device to:
estimate a performance state value of the device by monitoring a performance state of the device in real time;
determine, based on the estimated performance state value, whether to change the neural network (NN) model;
perform rendering by using a selected NN model that is selected according to a result of the determining whether to change the NN model; and
determine whether to change the selected NN model by monitoring a result of the rendering and the performance state of the device in real time.
